(19) United States
(12) Patent Application Publication
(10) Pub. No.: US 2003/0221498 A1
(43) Pub. Date: Dec. 4, 2003

(54) Control knob to position encoder interface with self-aligning rotary guide

(76) Inventors: Shadi Mere, Ypsilanti, MI (US); Douglas A. Pfau, Canton, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/158,573

(22) Filed: May 30, 2002

(51) Int. Cl. F16H 35/18

(52) U.S. Cl. 74/10.2

(57) ABSTRACT

A control panel is provided comprising a circuit board, a rotary position encoder mounted to the circuit board and having a rotating shaft with a first rotation axis, and a cover having an aperture. A knob is rotationally received in the aperture with a second rotation axis. The knob has an open interior space and a radial guiding rib projecting into the interior space. A guide part rotates with the rotating shaft and has a guide groove slidably engaging the radial guiding rib whereby the radial guiding rib drives rotation of the rotating shaft in response to manual rotation of the knob. The radial guiding rib shifts in position within the guide groove in response to misalignment between the first rotation axis and the second rotation axis.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to position encoders for control panels, and, more specifically, to interfacing a manual control knob with a rotary position encoder when an aperture in the control panel for receiving the knob is misaligned with a shaft of the position encoder.

Use of a rotary position encoder (e.g., a quadrature pulse encoder or a potentiometer) is popular in many types of control panels, such as a volume control knob for an automotive audio system. The encoder is typically mounted to a printed circuit board that also carries other components such as a visual display (e.g. vacuum fluorescent or LCD), membrane switches, and a microcontroller. A bezel for covering the control panel includes apertures for the control knob and other switches. In the interior space of the control panel, the control knob is coaxially attached to a rotating shaft of the position encoder. The distal end of the knob extends through a respective aperture in the bezel so that it can be manually grasped by a person for adjusting the shaft position (e.g., increasing or decreasing audio volume).

The aperture opening of the bezel must be properly aligned with the location of the shaft of the rotary position encoder in order to prevent interference between the knob and the edge surfaces of the aperture. The printed circuit board has a pre-specified size and shape and may include position registration features that align with corresponding features of the bezel or other intervening parts. However, manufacturing processes have inherent tolerances such that there are minor variations between actual parts and the position of the encoder shaft can only be controlled within these tolerances. Likewise, the size and location of the aperture is subject to its own tolerance. The tolerances may “build up” in incompatible directions, causing a misalignment severe enough that a crash condition between the knob and the aperture is created.

One typical prior art solution to this problem has been to provide in the nominal design of the control panel a sufficient gap between the knob and the aperture to accommodate the misalignment corresponding to the worst case tolerance build up. This has typically required a gap of about 1 millimeter, which is undesirable for several reasons. When there is a misalignment, the knob is off-center in the gap (i.e., the gap is uneven around the circumference). The uneven gap has a negative impact on the ornamental appearance of the control panel and may give the appearance of poor craftsmanship. Even when the knob is not perceptibly off center, the large 1 millimeter gap still gives an undesirable, uncraftsmanlike appearance.

Another prior art solution has been to employ a spring-loaded shaft to compensate for misalignment between the encoder and the aperture for the knob. This has allowed for use of a tighter fitting aperture around the knob, but the spring-loaded shaft adds expense to the control panel. Since the axis of shaft rotation is not coaxial with the axis of rotation of the knob in this design, a more complex and failure prone joint must be employed between the shaft and the knob. Furthermore, the tactile feel of the knob rotation suffers.

### SUMMARY OF THE INVENTION

The present invention provides a cost effective and easily manufactured knob to encoder interface with the advantage of avoiding rubbing or interference between the knob and aperture without introducing a large gap at the periphery of the knob.

In one aspect of the invention, a control panel is provided comprising a circuit board, a rotary position encoder mounted to the circuit board and having a rotating shaft with a first rotation axis, and a cover having an aperture. A knob is rotationally received in the aperture with a second rotation axis. The knob has an open interior space and a radial guiding rib projecting into the interior space. A guide part rotates with the rotating shaft and has a guide groove slidably engaging the radial guiding rib whereby the radial guiding rib drives rotation of the rotating shaft in response to manual rotation of the knob. The radial guiding rib shifts in position within the guide groove in response to misalignment between the first rotation axis and the second rotation axis.

### BRIEF DESCRIPTION OF THE DRAWINGS

FIG. 1 is a perspective, exploded view of portions of a control panel.

FIG. 2 is a rear perspective, exploded view of a knob to encoder interface of the present invention.

FIG. 3 is a front perspective, exploded view of the interface of FIG. 2.

FIG. 4 is a perspective view showing more of the interior of the knob of FIGS. 2 and 3.

FIG. 5 is a side cross section through an assembled bezel, knob, guide, encoder, and circuit board.

FIG. 6 is a perspective exploded view of the control panel employing the present invention.

FIG. 7 is a partial cross-sectional view showing the sliding relationship of the guiding rib within a guide groove during knob rotation.

FIG. 8 is a rear perspective view showing how a knob is assembled between a bezel front plate and a bezel backing plate.

FIG. 9 is a front perspective view of an assembled guide part and encoder prior to bringing the circuit board together with a bezel assembly.

### DETAILED DESCRIPTION OF PREFERRED EMBODIMENTS

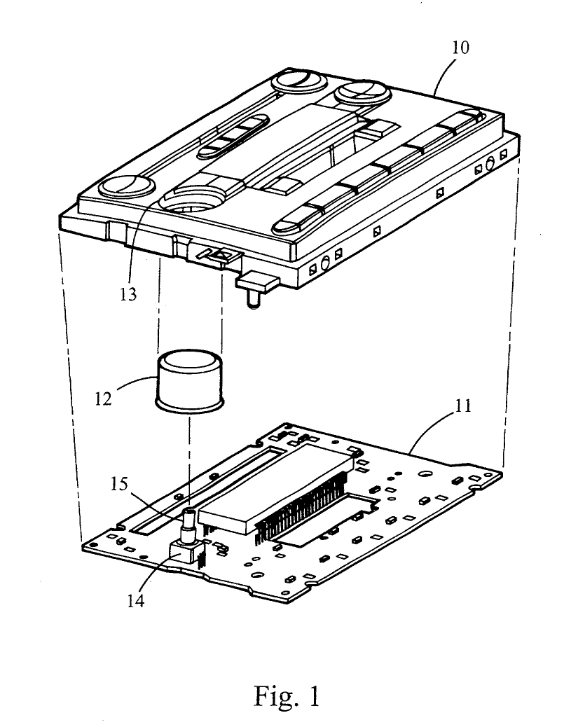

Referring to FIG. 1, a control panel comprises a bezel assembly 10 and a printed circuit board 11. Bezel assembly 10 houses a plurality of knobs and push buttons including a knob 12 being received in an aperture 13. Knob 12 is mechanically coupled to a rotary position encoder 14 via its rotating shaft 15. Encoder 14 generates a control signal in response to rotation of shaft 15, such as an audio volume control signal when the control panel is attached to a head unit of an automotive audio system. Other uses include encoders for adjusting other audio parameters (e.g., tone, balance, fade), climate control parameters (e.g., temperature) on a climate control module, light dimming for a display, and many other applications. The control panel comprising the bezel and circuit board joined together is typically mounted to the front of a sheet metal enclosure for an electronic module (not shown).

In conventional control panels, knob 12 typically included an integral socket to fixedly receive shaft 15. Thus, the precise location of knob 12 relative to aperture 13 was controlled by the relative position of encoder 14 to aperture 13. Due to the tolerance build up between encoder 14 and aperture 13, the size of aperture 13 was enlarged to allow knob 12 to turn freely within aperture 13 even when a misalignment occurred.

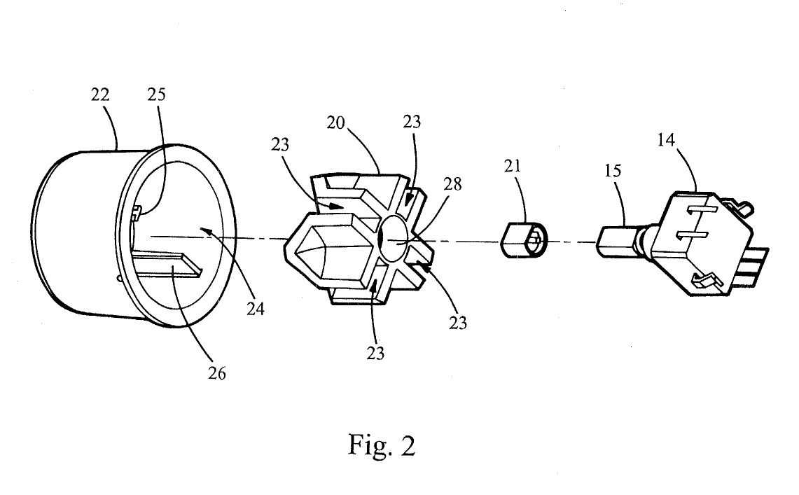

One embodiment of a knob-to-encoder interface of the present invention for allowing free knob rotation even in the presence of a misalignment and without enlarging the aperture is shown in FIG. 2. A guide part 20 is retained on shaft 15 via a D-clip 21 and is received by a knob 22 in an open interior space 24. D-clip 21 has a D-shape matching the outside shape of shaft 15 and the inside shape of an internal shaft-retaining socket within a bore 28 of guide part 20, so that guide part 20 is locked on and rotates with shaft 15.

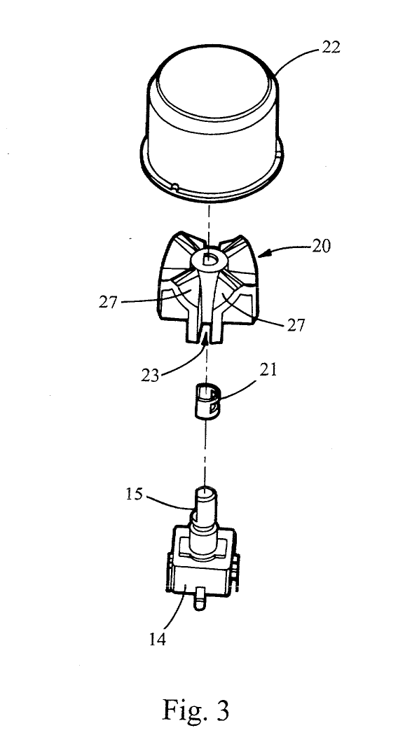

Guide part 20 has a plurality of radial guide grooves 23 which slidably receive at least one radial guiding rib 25 that projects into interior space 24. Radial guiding rib 25 drives rotation of guide part 20, and consequently shaft 15, by bearing against the walls of corresponding groove 23 in response to manual rotation of knob 22. Radial guiding rib 25 shifts radially in position within guide groove 23 in response to misalignment (i.e., offset) between the rotation axis of shaft 15 and the rotation axis of knob 22 as the two rotate. While only one guiding rib 25 is needed to transfer the rotation from knob 22 to guide part 20, a radial alignment rib 26 is also provided diametrically opposite from rib 25 in order to help with the insertion of rib 25 into a groove 23 during assembly. As shown in FIG. 3, guide part 20 may also include guide ramps 27 which are sloped in order to rotate knob 22 by bearing against the leading edge of alignment rib 26 during insertion.

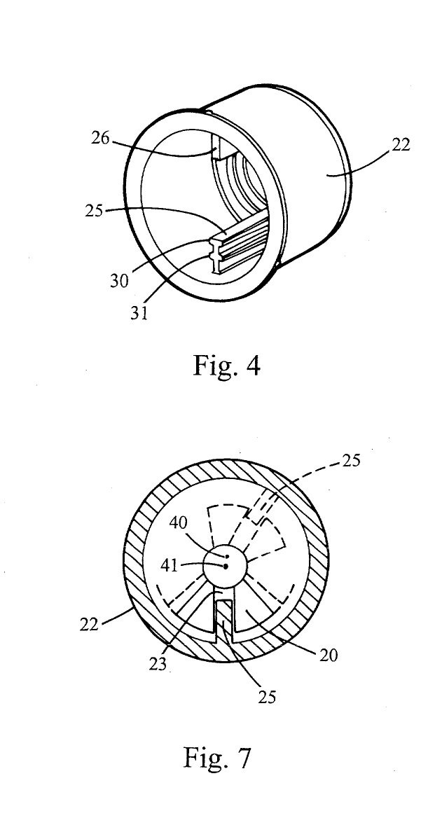

As shown in FIG. 4, guiding rib 25 may include one or more transverse secondary ribs 30 and 31. In order to be slidable within a groove 23, the transverse width of guiding rib 25 is slightly less than the width of groove 23 (e.g., about 0.4 mm less). The groove must be wide enough to provide sufficient play so that the guiding rib can pivot slightly (since the radial line of the rib may not pass through the central axis of the shaft). Thus, a groove width of about 3 mm may be employed. A countervailing concern for the width of rib 25 is that it should be less than about 60% of the thickness of the knob wall in order to avoid molding sink-deformation of the outside knob surface proximate to the rib. Therefore, the width of rib 25 at the interface with the knob outer wall is reduced (while still maintaining the necessary transverse thickness for driving the guide part) by using transverse secondary ribs 30 and 31.

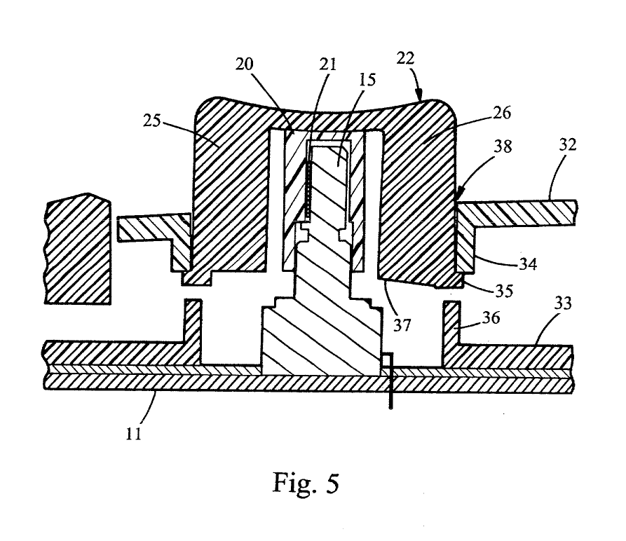

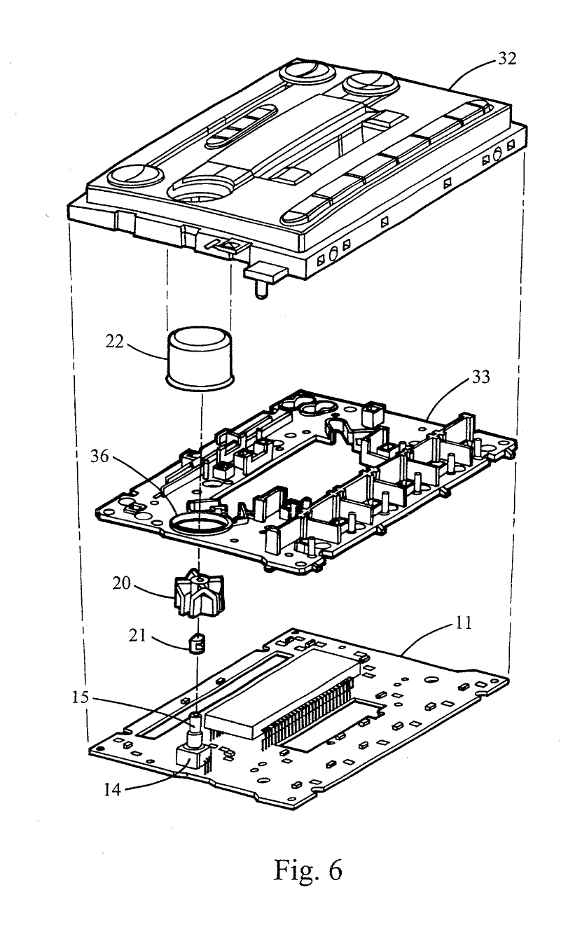

FIG. 5 is a cross section of an assembled control panel. The bezel includes a front plate 32 and a back plate 33 that retain knob 22 between them. Aperture 13 is bounded by a collar 34. Knob 22 has an annular flange 35 at its lower end. Back plate 33 has an annular collar 36 for cooperating with collar 34 to sandwich flange 35 therebetween and to allow smooth rotation of knob 22 without jitter or wobble. In one preferred embodiment, alignment rib 26 extends a farther distance toward the lower end of knob 22 than guiding rib 25. In addition, a sloped edge 37 may be provided to facilitate the self-alignment of knob 22 and guide part 20 during insertion.

Due to the knob to encoder interface of the present invention, a knob clearance 38 is maintained that is determined by tolerances involving the plastic molding of the knob and the bezel plates, and not by any tolerances in locating the encoder. Thus, clearance 38 can be kept in the range of about 0.1 to about 0.15 millimeters.

FIG. 7 shows how the interface operates to contend with an offset between the rotation axes of the knob and the encoder shaft. Knob 22 has a center axis of rotation 40. The encoder shaft and guide part 20 have a center axis of rotation 41. In a first position shown by solid lines, guiding rib 25 extends a first distance into groove 23 toward axis 40. By turning knob 22, rib 25 bears against a side wall of groove 23 and drives them both toward a second position shown by dashed lines. During rotation, rib 25 slides radially in groove 23 because of the offset in their axes of rotation. In the second position, rib 25 has slid outward in groove 23.

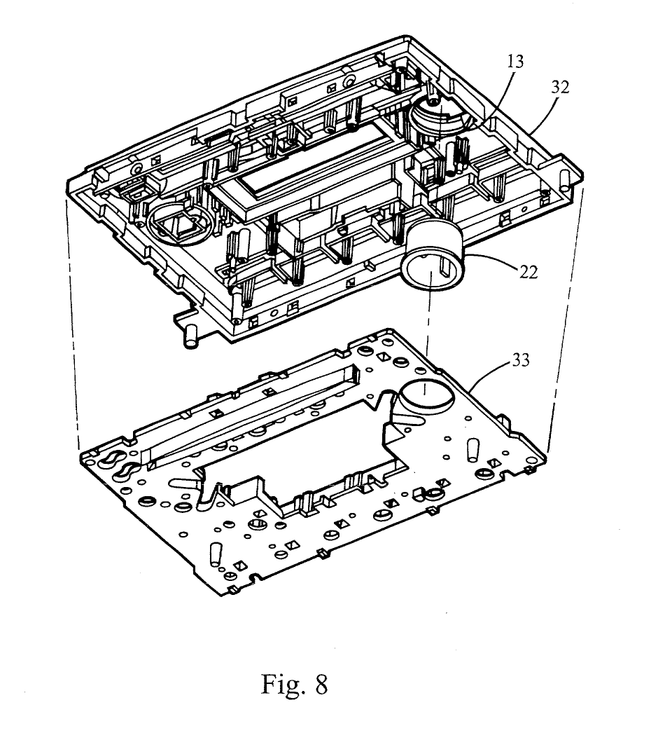

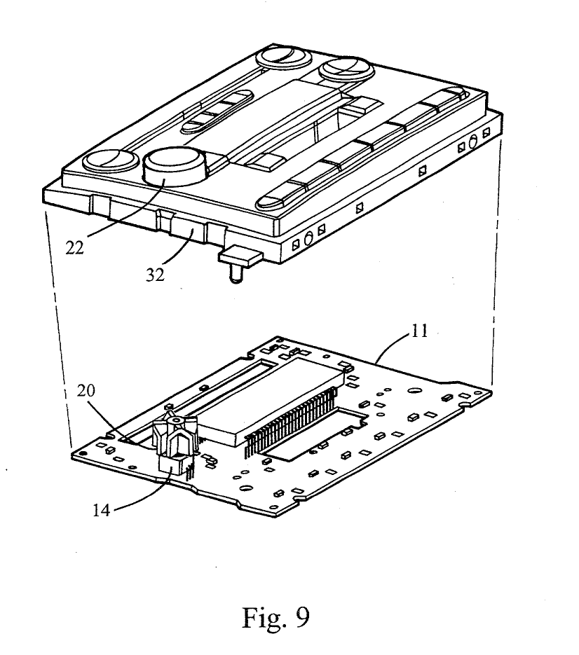

In a preferred method of assembling the knob to encoder interface, knob 22 is assembled to bezel plates 32 and 33 as shown in FIG. 8. Knob 22 and other knobs or push buttons (not shown) of the control panel are inserted into their respective apertures in front plate 32. Then back plate 33 is attached to front plate 32 (e.g., by snapping, use of attachment screws, or heat staking), thereby capturing the knobs and push buttons in place. As shown in FIG. 9, guide part 20 is mounted on the shaft of rotary position encoder 14 which has already been mounted to circuit board 11.

Guide part 20 and the encoder shaft turn freely together. The circuit board assembly having the encoder and guide part is then brought together with the bezel assembly (i.e., cover) having the knob captured in the aperture. As the two are brought together, the internal rib(s) of the knob are inserted into a respective groove(s) in the guide part. If there are more than one rib, then their spacing matches the spacing of grooves of the guide part. If a rib is not already aligned with a groove during insertion, it first contacts a guide ramp so that the two self-align. By providing an alignment rib which is relatively thinner than the radial guiding rib and which extends farther toward the guide part, the self-alignment during said step of bringing together is improved. By being thinner and substantially diametrically opposite from the guiding rib, the alignment rib does not interfere with mutual rotation of the knob and the guide part.

Although the guide part has been shown as a separate piece, it could be formed integrally with the encoder shaft and could have a different number of grooves. If only one rib is provided on the knob, then the guide part does not need grooves that are diametrically aligned.

What is claimed is:

1. A control panel comprising:
a circuit board;
a rotary position encoder mounted to said circuit board and having a rotating shaft with a first rotation axis;
a cover having an aperture;
a knob rotationally received in said aperture with a second rotation axis, said knob having an open interior space and a radial guiding rib projecting into said interior space; and
a guide part rotating with said rotating shaft and having a guide groove slidably engaging said radial guiding rib whereby said radial guiding rib drives rotation of said rotating shaft in response to manual rotation of said knob, said radial guiding rib shifting in position within said guide groove in response to misalignment between said first rotation axis and said second rotation axis.

2. The control panel of claim 1 wherein said guide part is a separate molded piece mounted on said rotating shaft.

3. The control panel of claim 1 wherein said guide part includes a plurality of guide grooves and wherein said knob further includes an assembly rib projecting into said interior space, said assembly rib being relatively thinner than said radial guiding rib and arranged to engage a respective guide groove before said radial guiding rib engages a guide groove during assembly.

4. The control panel of claim 3 wherein said guide part further includes a plurality of guide ramps for guiding said ribs into said respective grooves during assembly.

5. The control panel of claim 3 wherein said radial guiding rib and said assembly rib are substantially diametrically opposed within said interior space.

6. The control panel of claim 1 wherein said radial guiding rib comprises a transverse secondary rib for bearing against said guide groove.

7. The control panel of claim 1 wherein said control panel controls an audio system of a transportation vehicle.

8. The control panel of claim 1 wherein said rotary position encoder controls a volume setting of said audio system.

9. Control knob apparatus comprising:
a rotary position encoder having a rotating shaft with a first rotation axis;
a knob having an open interior space and a radial guiding rib projecting into said interior space, said knob rotating around a second rotation axis which is substantially parallel with said first rotation axis; and
a guide part rotating with said rotating shaft and having a guide groove slidably engaging said radial guiding rib whereby said radial guiding rib drives rotation of said rotating shaft in response to manual rotation of said knob, said radial guiding rib shifting in position within said guide groove in response to misalignment between said first rotation axis and said second rotation axis.

10. The apparatus of claim 9 wherein said guide part is a separate molded piece mounted on said rotating shaft.

11. The apparatus of claim 9 wherein said guide part includes a plurality of guide grooves and wherein said knob further includes an assembly rib projecting into said interior space, said assembly rib being relatively thinner than said radial guiding rib and arranged to engage a respective guide groove before said radial guiding rib engages a guide groove during assembly.

12. The apparatus of claim 11 wherein said guide part further includes a plurality of guide ramps for guiding said ribs into said respective grooves during assembly.

13. The apparatus of claim 11 wherein said radial guiding rib and said assembly rib are diametrically opposed within said interior space.

14. The apparatus of claim 9 wherein said radial guiding rib comprises a transverse secondary rib engaging said guide groove.

15. A method of assembling a control panel having a knob projecting through an aperture in a cover for manual rotation of a rotary position encoder mounted on a circuit board behind said cover, wherein a first axis of rotation of a shaft of said rotary position encoder can be offset from a second axis of rotation of said knob within said aperture, said method comprising the steps of:
providing an open interior space within said knob and a radial guiding rib projecting from said knob into said interior space;
providing a radial guide groove for fixed rotation with said shaft;
mounting said knob within said aperture; and
bringing together said cover and said circuit board so that said radial guiding rib slidably engages said radial guide groove, whereby said radial guiding rib drives rotation of said shaft in response to manual rotation of said knob and whereby said radial guiding rib shifts in position within said radial guide groove during said manual rotation in response to said offset.

16. The method of claim 15 wherein a plurality of said radial guide grooves are provided, wherein each radial guide groove is bounded by guide ramps facing said knob, wherein an alignment rib is provided projecting from said knob into said interior space substantially diametrically opposite from said radial guide rib, wherein said alignment rib is relatively thinner than said radial guiding rib, and wherein said alignment rib rides one of said guide ramps during said step of bringing together.
